(19) United States
(12) Patent Application Publication
(10) Pub. No.: US 2019/0039548 A1
(43) Pub. Date: Feb. 7, 2019

(54) COMPREHENSIVE ROOF AIRBAGS FOR OPENTOP, CONVERTIBLE AND CLOSED TOP VEHICLES

(71) Applicant: PRASAD MUTHUKUMAR, NADU (IN)

(72) Inventor: PRASAD MUTHUKUMAR, NADU (IN)

(21) Appl. No.: 15/757,688

(22) PCT Filed: Sep. 12, 2016
(86) PCT No.: PCT/IN2016/000227

§ 371 Date: Mar. 6, 2018

(51) Int. Cl. B60R 21/13; B60R 21/214; B60R 21/0132; B60R 21/233; G01C 21/12; G01S 13/93; G01S 19/13; G01S 13/86

(52) U.S. Cl. CPC B60R 21/13; B60R 21/214; B60R 21/0132; B60R 21/233; B60R 2021/0048; G01S 13/931; G01S 19/13; G01S 13/867; B60R 2021/138; G01C 21/12

(57) ABSTRACT

During a rollover situation there are possibilities of passenger head hitting the roof of the vehicle causing injury depending upon the passenger's height, head room, vertical and angular momentum where only side and curtain airbags cannot provide a complete head and neck protection. Comprehensive Roof Airbags (CRA) are integrated or installed internally and externally between, through and across the top of windshield, top of the roll over protection bars, head liner, roof rails, top of A, B and C pillars particularly works in roll over situation and deployed to cover the area with airbags on either one or more or combinations of inside headliner, outside rooftop and over the top of occupants head according to configurations and type of the vehicles thereby forming a protective layer to prevent or reduce the severity of head hitting the roof top in closed top vehicles and head hitting the road surface and debris in case open top vehicle ultimately to protect the passengers all to avoid or mitigate the head, neck and spine injury.

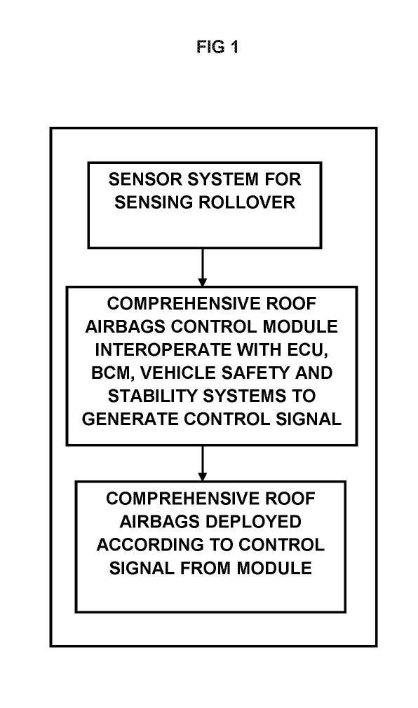

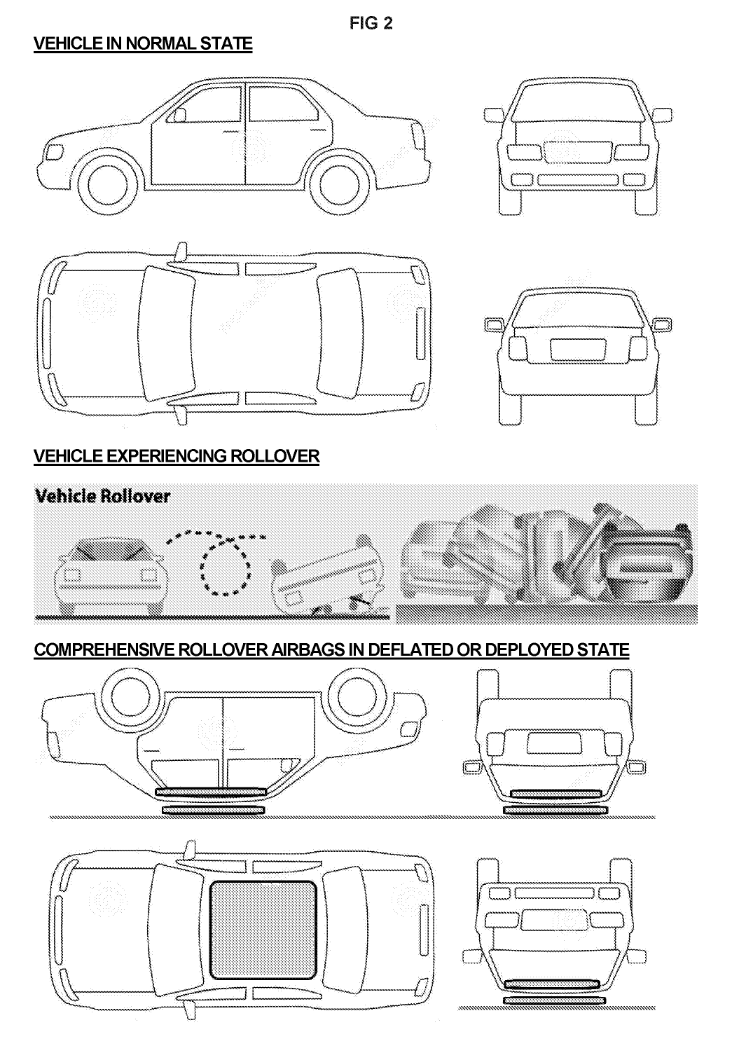

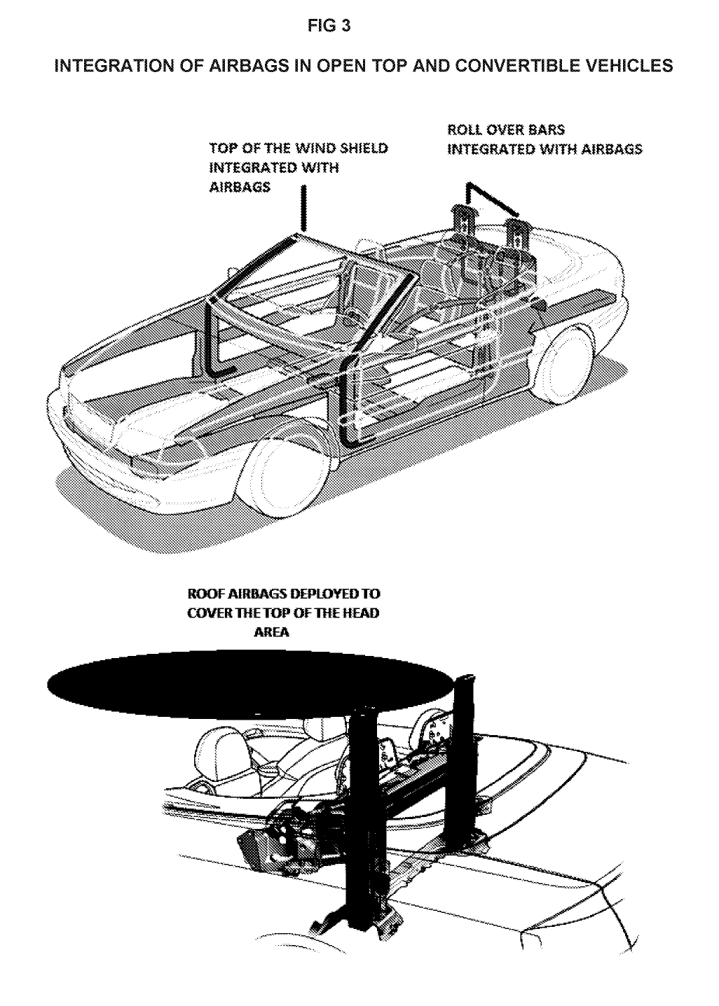

### FIELD OF INVENTION

The present invention is related to automobile or transportation safety domain and more particularly into vehicles comprehensive roof top airbags.

### OBJECTIVE

The primary aim of The Comprehensive Roof Airbags/Complete Roof Airbags (CRA) is to efficiently protect the passengers in a roll over scenario.

### BACKGROUND AND PROBLEM STATEMENT

Front, side, curtain, centre, seatbelt, pedestrian and nee airbags generally won't provide over the head protection to occupants in case of rollover accidents. However, side airbags may inflate during a rollover, depending on the precise impacts which the side of the vehicle experienced during a rollover. During roll over situation there are scenarios where only side and curtain airbags cannot provide complete protection to head and neck. There are possibility of passenger head hitting the roof of the vehicle causing injury, depending upon the passenger's height, head room, vertical and angular momentum. In case of open top and convertibles beyond rollover bars the head can even get in direct contact with road surface and things like debris in a rollover scenario.

The absence of comprehensive roof airbags could leads to severe head and neck injuries, head trauma; traumatic brain injuries (TBI); skull fractures; facial injuries; spinal cord injuries; cervical spine fractures or dislocations; paralysis (paraplegia, quadriplegia); arm and hand injuries, including traumatic amputation; chest injuries; heart injuries; pelvic injuries; bone fractures/orthopedic injuries; flail chest; and numerous other injuries. These injuries can occur whether you are inside your car or ejected.

### HIGHLIGHTS

The Comprehensive Roof Airbags (CRA) are either one or more and divided into multiple sections, segments and stages are utilised for covering complete vehicle roof top area either inside or outside or both during an roll over to protect the passengers.
Sensors comprising IMS and Crash sensors and interoperate with Engine Control Unit (ECU), Body Control Module (BCM), vehicle safety and stability systems to control the deployment of the airbags.
The CRA are implemented for closed, convertible and open top vehicles.
The CRA are assembled or installed internally and externally between and across the top of A, B and C pillars, rood rails, rollover protection bars.

### DESCRIPTION

To address the issues with the current side and curtain airbags, the CRA provides an enhanced passenger protection.

According to one aspect during rollover scenario the CRA works, deflates and deploys the airbags in the inner side of the vehicle roof top to protect the passenger by mitigating or avoiding the head and neck injury.

According to another aspect during rollover scenario the CRA works, deflates and deploys the airbags in the outer side of the roof top to protect the passenger by mitigating or avoiding the head and neck injury.

According to another aspect in case of open top and convertible vehicles experiencing rollover scenario the CRA works, deflates and deploys the airbags above the passenger head to protect the passenger by forming a protective layer to avoid or mitigate the heads' direct contact with the debris.

According to another the airbags could be either individually/segmentally or comprehensively cover the portion or area to protect the passengers.

According to another aspect the CRA deploys airbags to protect the passenger during a Run Off Road situations

According to another aspect the roll over bars are integrated with airbags to cover the roof area to protect the head and neck.

According to another aspect the A-Pillar and top of the windshield integrated with airbags to deploy on the top of the passengers

According to another aspect the roll cage is integrated with airbags to protect the occupants.

According to another aspect in an severe frontal, angular and side impact there are chances of occupants head hitting the top of the vehicles where the CRA senses, deploys the airbags and protects the occupants.

According to another aspect during a roll over situations the CRA deploys the airbags externally on the roof top to provide a protective layer to mitigate the roof top deformation and shockwave thereby reducing the severity of the impact.

The embodiments of the present invention is not limited to listed scenarios described here or its combinations and the above presented are just examples. There may be other scenarios and those who skilled in field can understand and modify, enhance, alter the herein system without departing from the scope of the invention in its widest form.

1. A Comprehensive Roof Airbags (CRA) for open-top, convertible and closed top vehicles comprising:
a) a Comprehensive Roof Airbags which are integrated or installed internally and externally between, through and across the roll over protection bars, top of windshield, head liner, roof rails, top of A, B and C pillars particularly deployed to cover the area with airbags on either one or more or combinations of inside headliner, outside rooftop and over the top of occupants head according to configurations and type of the vehicles thereby to prevent or reduce the severity of head hitting the roof top in closed top vehicles and head hitting the road surface and debris in case open top vehicle ultimately to protect the passengers by avoiding or mitigating the head, neck and spine injury.
b) a sensor system for actively monitoring, sensing and generating trigger signal to processing unit by detecting the vehicle's critical situations particularly comprising of but not limited to rollover;
c) a processing unit which is a highly time sensitive design that computes and directs the control signal to Airbag Control Module (ACM);
d) an Airbag Control Module (ACM) works based on the control signal from processing unit and actively works to deploy comprehensive roof top airbags to completely cover either one or both inside headliner and outside rooftop of the vehicle according to vehicle configuration particularly during imminent and inevitable critical roll over situations to protect the occupant through avoiding or mitigating the head, neck and spine injury;
e) the Comprehensive Roof Airbags (CRA) performs active monitoring and sensing, pre-computing and set ready to control the roof airbags prior to critical situation, current-computing to control the airbags during critical situation, post-computing to sustain the deployed airbags after overcoming the critical situations all to protect the occupants.

2. The CRA said in claim 1, comprise of sensor system that works based on one or combination of sensors, safety and stability parameters, configurations, operating modes and usage scenarios for detecting the critical situations of vehicles experiencing or moving beyond the limits of vehicles available safety and stability systems comprising:
a) Inertial Measurement Unit [IMU] to measures and reports vehicles experiencing specific force and angular rate using a combination of accelerometers, gyroscopes and magnetometer;
b) CRA senses and utilises parameters collected form vehicles already available crash sensors;
c) CRA senses and utilised parameters available with vehicle Body Control Module [BCM], Engine Control Unit [ECU], safety and stability systems
d) vehicle speed and wheel speed sensor;
e) orientation sensors and accelerometer for sensing the vehicles orientation, acceleration and deceleration;
f) load sensor for sensing the load of the vehicle, load on individual wheel tyres and change in centre of gravity;
g) steering angle or position sensor for sensing the position of the steering wheel and vehicles relative motion thereby sensing vehicle stability, over and under steering;
h) brake force sensor;
i) radar and range sensors for scanning the environment around the vehicle by detecting vehicles, pedestrians and objects in front, rear and around the vehicle with its direction, dimension, distance, nature, approaching and departing speed with respect to the vehicle; the radar system comprises of visual, active and passive infrared cameras with real time digital image and signal processing thereby to sense the nature of the objects around the vehicle;
j) terrain, road or contact area sensors for sensing the nature of present contact and impending road and terrain surfaces with its property comprising of normal dry roads, wet, mud and ruts, rocks, gravel, grass, snow, sand, rough, highly uneven terrain, rocky crawl and its combinations;
k) GPS, location and positioning sensors for predicting the turns, curves and bends ahead of the road.

3. The CRA said in claim 1, works, deflates and deploys the airbags during rollover in the inner side of the vehicle roof top to protect the passenger by mitigating or avoiding the head and neck injury.

4. The CRA said in claim 1, works, deflates and deploys the airbags during roll over scenario in the outer side of the roof top to protect the passenger by mitigating or avoiding the head and neck injury.

5. The CRA said in claim 1, operate with open top and convertible vehicles experiencing rollover scenario where the CRA works, deflates and deploys the airbags above the passenger head to protect the passenger by forming a protective layer to avoid or mitigate the head's direct contact with the debris.

6. The CRA said in claim 1, where the airbags are either individually/segmentally or comprehensively deployed to cover the portion or area over the head to protect the passengers.

7. The CRA said in claim 1, where the CRA deploys airbags to protect the passenger during a Run Off Road situations.

8. The CRA said in claim 1, where the roll over bars is integrated with airbags to cover the roof area and over the head to protect the passengers.

9. The CRA said in claim 1, where the roll cage is integrated with airbags to protect the occupants.

10. The CRA said in claim 1, where the CRA sense and deploys airbags during potential head hitting the top of the vehicles in a severe frontal, rear, angular and side impact to protects the occupants.

11. The CRA said in claim 1, where the CRA deploys the airbags externally on the roof top during a roll over situations to provide a protective layer to mitigate the roof top deformation and shockwave thereby reducing the severity of the impact.
